(19) United States
(12) Patent Application Publication
(10) Pub. No.: US 2022/0261617 A1
(43) Pub. Date: Aug. 18, 2022

(54) APPARATUS, SYSTEM AND METHOD FOR TRANSLATING SENSOR DATA

(71) Applicant: VOLKSWAGEN AKTIENGESELLSCHAFT, Wolfsburg (DE)

(72) Inventors: Pratik Prabhanjan Brahma, Belmont, CA (US); Nasim Souly, San Mateo, CA (US); Oleg Zabluda, Redwood City, CA (US); Adrienne Othon, Kensington, CA (US)

(21) Appl. No.: 17/179,196

(22) Filed: Feb. 18, 2021

(51) Int. Cl. G06N 3/04; G06N 3/08

(52) U.S. Cl. CPC G06N 3/0454; B60W 50/0098; G06N 3/08

(57) ABSTRACT

Technologies and techniques for operating a sensor system. First sensor data is received that is generated using a first sensor. Second sensor data is received that is generated using a second sensor, wherein the first sensor data includes a first operational characteristic capability, and the second sensor data includes a second operational characteristic capability. A machine-learning model may be trained/applied, wherein the machine-learning model is trained to output the second sensor data based on input of the first sensor data. New sensor data is generated using the applied machine-learning model. A loss function may be applied to the new sensor data to determine the accuracy of the new sensor data relative to the first sensor data and the second sensor data.

### TECHNICAL FIELD

The present disclosure relates to processing and translating sensor data from two sensors. More specifically, the present disclosure relates to technologies and techniques for processing and translating sensor data from two similar operating platforms utilizing machine learning algorithms.

### BACKGROUND

Numerous devices and systems are configured today to utilize multiple sensors. In the case of autonomous vehicles, the ability to navigate a vehicle is dependent upon having accurate and precise sensor data, in order to operate in a safe and reliable manner. Many of today's autonomous vehicles are typically equipped with different sensor suites and are calibrated to suit the specific application of the vehicle. During the course of operation, autonomous vehicles will typically require sensor upgrading and/or replacement in order to maintain the vehicle's operational capacity.

One of the issues experienced during sensor replacement and/or upgrade is coordinating the operation of the new or upgraded sensor(s) with the existing autonomous vehicle system. Currently, light detection and ranging (sometimes referred to as active laser scanning), or LiDAR sensors have experienced large growth in the industry. Each LiDAR sensor is typically configured with different physical properties, based on the type of photon emitted, scanning patterns, transmitter-receiver characteristic, and so on. In order to replace one LiDAR with another, machine learning techniques (generally known as “artificial intelligence”, or “AI”) are used for the existing vehicle system to “learn” the properties of the new LiDAR. In order for a machine-learning model to be able to transfer data from one sensor (e.g., LiDAR) to another, the model has to understand the properties of each sensor, as well as the structure of the objects visible in a point cloud to resolutions in multiple scales. In most cases, this learning process is excessively time-consuming and often expensive to implement. Similar issues arise for other types of sensors, such as cameras, when changing a first sensor with a second sensor.

In some cases, a user may want to operate a first sensor (source sensor) in a manner that simulates or emulates at least one operating characteristic of a second sensor (target sensor). Current techniques for such operation often include up-sampling and related techniques to “upgrade” a sensor from a low-resolution sensor to a higher resolution sensor, and further include machine-learning algorithms such as neural networks to estimate denser data from lower-resolution (sparse) data. However, such techniques typically rely only on point cloud data, and/or are configured to consume only three-dimensional (3D) volumes as inputs, or output shapes in voxel representations, which is inefficient.

### SUMMARY

Various apparatus, systems and methods are disclosed herein relating to operating a sensor system. In some examples, a method of operating a sensor is disclosed, comprising receiving first sensor data generated using a first sensor and second sensor data generated using a second sensor, wherein the first sensor data comprises a first operational characteristic capability, and wherein the second sensor data comprises a second operational characteristic capability; training a machine-learning model, wherein the machine-learning model is trained to output the second sensor data based on input of the first sensor data; generating new sensor data using the applied machine-learning model; and applying a loss function to the new sensor data to determine the accuracy of the new sensor data relative to the first sensor data and the second sensor data.

In some examples, a system is disclosed for converting sensor data from a first operational characteristic to a second operational characteristic, comprising an input for receiving first sensor data from a first sensor, wherein the first sensor data comprises a first operational characteristic capability; a memory, coupled to the input for storing the first sensor data; and a processor, operatively coupled to the memory, wherein the processor and memory are configured to receive first sensor data generated using a first sensor and second sensor data generated using a second sensor, wherein the first sensor data comprises a first operational characteristic capability, and wherein the second sensor data comprises a second operational characteristic capability, train a machine-learning model, wherein the machine-learning model is trained to output the second sensor data based on input of the first sensor data, generate new sensor data using the applied machine-learning model, and apply a loss function to the new sensor data to determine the accuracy of the new sensor data relative to the first sensor data and the second sensor data.

In some examples, a method is disclosed for operating a sensor system, comprising receiving first sensor data generated using a first sensor and second sensor data generated using a second sensor, wherein the first sensor data comprises a first operational characteristic capability, and wherein the second sensor data comprises a second operational characteristic capability; training a machine-learning model, wherein the machine-learning model is trained to output the second sensor data based on input of the first sensor data; generating new sensor data using the applied machine-learning model, wherein the new sensor data comprises data converted from the first sensor data to the second sensor data corresponding to at least the one or more features of interest; and applying a loss function to the new sensor data to determine the accuracy of the new sensor data relative to the first sensor data and the second sensor data

### BRIEF DESCRIPTION OF THE FIGURES

The present invention is illustrated by way of example and not limitation in the figures of the accompanying drawings, in which like references indicate similar elements and in which:

FIG. 1 shows an exemplary vehicle system block diagram showing multiple components and modules according to some aspects of the present disclosure;

FIG. 2 shows an exemplary network environment illustrating communications between a vehicle and a server/cloud network according to some aspects of the present disclosure;

FIG. 3 shows an exemplary block diagram for applying machine learning models to paired sensor data and translating the results according to some aspects of the present disclosure;

FIG. 4 shows an exemplary block diagram for applying machine learning models for one-way unpaired sensor data processing and translating the results according to some aspects of the present disclosure;

FIG. 5 shows an exemplary block diagram for applying machine learning models to unpaired sensor data and translating the results according to some aspects of the present disclosure;

FIG. 6 shows an exemplary process flow for training paired sensor data and producing new sensor data resulting from the translation of first and second sensor data under some aspects of the disclosure;

FIG. 7 shows an exemplary process flow for training unpaired sensor data and producing new sensor data resulting from the translation of first and second sensor data under some aspects of the disclosure; and

FIG. 8 shows an exemplary process flow for applying new sensor data, produced from translating first sensor data to second sensor data via a machine-learning model, to a vehicle.

### DETAILED DESCRIPTION

The figures and descriptions provided herein may have been simplified to illustrate aspects that are relevant for a clear understanding of the herein described devices, structures, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Exemplary embodiments are provided throughout so that this disclosure is sufficiently thorough and fully conveys the scope of the disclosed embodiments to those who are skilled in the art. Numerous specific details are set forth, such as examples of specific components, devices, and methods, to provide this thorough understanding of embodiments of the present disclosure. Nevertheless, it will be apparent to those skilled in the art that specific disclosed details need not be employed, and that exemplary embodiments may be embodied in different forms. As such, the exemplary embodiments should not be construed to limit the scope of the disclosure. In some exemplary embodiments, well-known processes, well-known device structures, and well-known technologies may not be described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

The disclosed embodiments may be implemented, in some cases, in hardware, firmware, software, or any tangibly-embodied combination thereof. The disclosed embodiments may also be implemented as instructions carried by or stored on one or more non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

It will be understood that the term “module” as used herein does not limit the functionality to particular physical modules, but may include any number of tangibly-embodied software and/or hardware components. In general, a computer program product in accordance with one embodiment comprises a tangible computer usable medium (e.g., standard RAM, an optical disc, a USB drive, or the like) having computer-readable program code embodied therein, wherein the computer-readable program code is adapted to be executed by a processor (working in connection with an operating system) to implement one or more functions and methods as described below. In this regard, the program code may be implemented in any desired language, and may be implemented as machine code, assembly code, byte code, interpretable source code or the like (e.g., via Scalable Language (“Scala”), C, C++, C#, Java, Actionscript, Objective-C, Javascript, CSS, XML, etc.).

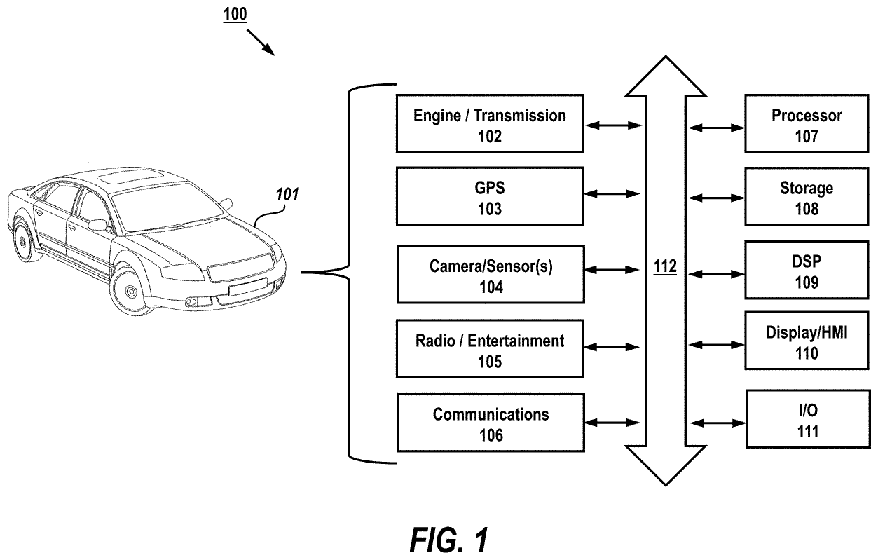

Turning to FIG. 1, the drawing illustrates an exemplary system 100 for a vehicle 101 comprising various vehicle electronics circuitries, subsystems and/or components. Engine/transmission circuitry 102 is configured to process and provide vehicle engine and transmission characteristic or parameter data, and may comprise an engine control unit (ECU), and a transmission control. For a diesel engine, circuitry 102 may provide data relating to fuel injection rate, emission control, NOx control, regeneration of oxidation catalytic converter, turbocharger control, cooling system control, and throttle control, among others. For a gasoline and/or hybrid engine, circuitry 102 may provide data relating to lambda control, on-board diagnostics, cooling system control, ignition system control, lubrication system control, fuel injection rate control, throttle control, and others. Transmission characteristic data may comprise information relating to the transmission system and the shifting of the gears, torque, and use of the clutch. Under one embodiment, an engine control unit and transmission control may exchange messages, sensor signals and control signals for any of gasoline, hybrid and/or electrical engines.

Global positioning system (GPS) circuitry 103 provides navigation processing and location data for the vehicle 101. The camera/sensors 104 provide image or video data (with or without sound), and sensor data which may comprise data relating to vehicle characteristic and/or parameter data (e.g., from 102), and may also provide environmental data pertaining to the vehicle, its interior and/or surroundings, such as temperature, humidity and the like, and may further include LiDAR, radar, image processing, computer vision and other data relating to autonomous (or “automated”) driving and/or assisted driving. Radio/entertainment circuitry 105 may provide data relating to audio/video media being played in vehicle 101. The radio/entertainment circuitry 105 may be integrated and/or communicatively coupled to an entertainment unit configured to play AM/FM radio, satellite radio, compact disks, DVDs, digital media, streaming media and the like. Communications circuitry 106 allows any of the circuitries of system 100 to communicate with each other and/or external devices (e.g., devices 202-203) via a wired connection (e.g., Controller Area Network (CAN bus), local interconnect network, etc.) or wireless protocol, such as 3G, 4G, 5G, Wi-Fi, Bluetooth, Dedicated Short Range Communications (DSRC), cellular vehicle-to-everything (C-V2X) PC5 or NR, and/or any other suitable wireless protocol. While communications circuitry 106 is shown as a single circuit, it should be understood by a person of ordinary skill in the art that communications circuitry 106 may be configured as a plurality of circuits. In one embodiment, circuitries 102-106 may be communicatively coupled to bus 112 for certain communication and data exchange purposes.

Vehicle 101 may further comprise a main processor 107 (also referred to herein as a “processing apparatus”) that centrally processes and controls data communication throughout the system 100. The processor 107 may be configured as a single processor, multiple processors, or part of a processor system. In some illustrative embodiments, the processor 107 is equipped with autonomous driving and/or advanced driver assistance circuitries and infotainment circuitries that allow for communication with and control of any of the circuitries in vehicle 100. Storage 108 may be configured to store data, software, media, files and the like, and may include sensor data, machine-learning data, fusion data and other associated data, discussed in greater detail below. Digital signal processor (DSP) 109 may comprise a processor separate from main processor 107, or may be integrated within processor 107. Generally speaking, DSP 109 may be configured to take signals, such as voice, audio, video, temperature, pressure, sensor, position, etc. that have been digitized and then process them as needed. Display 110 may consist of multiple physical displays (e.g., virtual cluster instruments, infotainment or climate control displays). Display 110 may be configured to provide visual (as well as audio) indicial from any circuitry in FIG. 1, and may be a configured as a human-machine interface (HMI), LCD, LED, OLED, or any other suitable display. The display 110 may also be configured with audio speakers for providing audio output. Input/output circuitry 111 is configured to provide data input and outputs to/from other peripheral devices, such as cell phones, key fobs, device controllers and the like. As discussed above, circuitries 102-111 may be communicatively coupled to data bus 112 for transmitting/receiving data and information from other circuitries.

In some examples, when vehicle 101 is configured as an autonomous vehicle, the vehicle may be navigated utilizing any level of autonomy (e.g., Level 0-Level 5). The vehicle may then rely on sensors (e.g., 104), actuators, algorithms, machine learning systems, and processors to execute software for vehicle navigation. The vehicle 101 may create and maintain a map of their surroundings based on a variety of sensors situated in different parts of the vehicle. Radar sensors may monitor the position of nearby vehicles, while video cameras may detect traffic lights, read road signs, track other vehicles, and look for pedestrians. LiDAR sensors may be configured bounce pulses of light off the car's surroundings to measure distances, detect road edges, and identify lane markings. Ultrasonic sensors in the wheels may be configured to detect curbs and other vehicles when parking. The software (e.g., stored in storage 108) may processes all the sensory input, plot a path, and send instructions to the car's actuators, which control acceleration, braking, and steering. Hard-coded rules, obstacle avoidance algorithms, predictive modeling, and object recognition may be configured to help the software follow traffic rules and navigate obstacles.

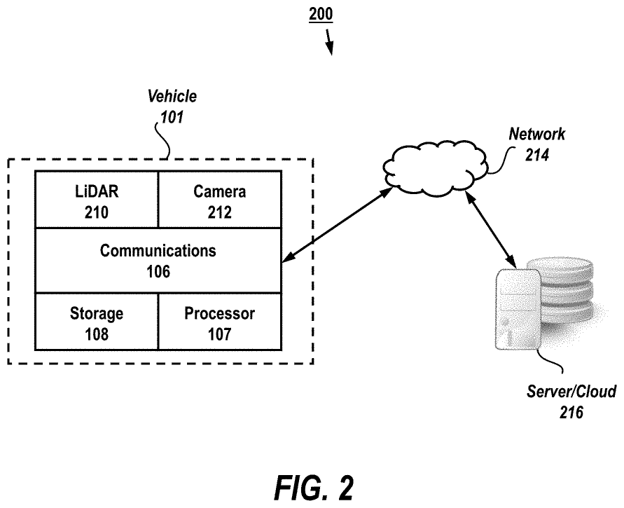

Turning to FIG. 2, the figure shows an exemplary network environment 200 illustrating communications between a vehicle 101 and a server/cloud network 214 according to some aspects of the present disclosure. In this example, the vehicle 101 of FIG. 1 is shown with storage 108, processing apparatus 107 and communications circuitry 106 that is configured to communicate via a network 214 to a server or cloud system 216. It should be understood by those skilled in the art that the server/could network 214 may be configured as a single server, multiple servers, and/or a computer network that exists within or is part of a cloud computing infrastructure that provides network interconnectivity between cloud based or cloud enabled application, services and solutions. A cloud network can be cloud based network or cloud enabled network. Other networking hardware configurations and/or applications known in the art may be used and are contemplated in the present disclosure.

Vehicle 101 may be equipped with multiple sensors, such as LiDAR 210 and camera 212, which may be included as part of the vehicle's sensor system (104), where LiDAR 210 produces LiDAR data for vehicle 101 operations, and camera 212 produces image data (e.g., video data) for vehicle 101 operations. The vehicle operations may include, but is not limited to, autonomous or semi-autonomous driving. The operational software for LiDAR 210 and/or camera 212 may be received via communications 106 from server/cloud 214 and stored in storage 108 and executed via processor 107. In one example, operational software for LiDAR 210 and/or camera 212 may alternately or in addition be loaded manually, e.g., via I/O 111. Depending on the application, the operational software may be periodically updated automatically and/or manually to ensure that the operating software conforms with the hardware components of the LiDAR 210 and/or camera 212.

When changing or modifying operational characteristics a sensor (e.g., 104, LiDAR 210, camera 212, etc.), the vehicle operator is faced with the issue of going through full cycles of data collection, labeling, model training, integration and testing, etc. in order to ensure the new sensor(s) operate properly in the vehicle. Conventionally, the data associated with an old sensor is not largely applicable to a new sensor that is replacing it, particularly if the old sensor has inferior operating characteristics (e.g., low-resolution) compared to the new sensor (e.g., high-resolution). In the case of LiDARs, as mentioned above, each LiDAR sensor has different physical characteristics, based on the type of photon it emits, scanning patters, transmitter-receiver characteristics, etc. Thus, for a machine-learning model to transfer data from one sensor to another, it has to understand the structure of the objects visible in a point clouds to provide resolution in multiple scales, as well as understand the properties of each sensor.

In some examples, technologies and techniques are disclosed for utilizing data from a sensor having first operating characteristics (source sensor) to “translate” the sensor operation into a second sensor having second operating characteristics (target sensor). In other words, a sensor (e.g., LiDAR, 210, camera 212, or some other sensor) having first operating characteristics may be configured to emulate a second sensor having second operating characteristics. In examples where a source sensor is trained using paired data (e.g., training outputs from the source and target sensor are processed contemporaneously), a machine-learning model may be utilized to translate the source sensor data to emulate the target sensor data. In examples where a source sensor is trained using unpaired sensors (e.g., training outputs from the source and target sensor are not processed contemporaneously) a machine-learning model may be utilized to translate the source sensor data, and then fed back to the machine-learning model to determine if the translated data still correlates to the first sensor data. In some example, encoder-decoder models may be used to implement the machine-learning.

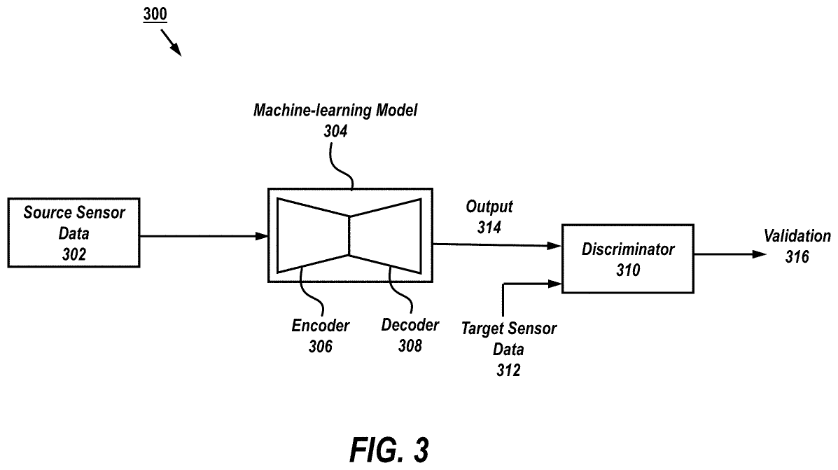

FIG. 3 shows an exemplary block diagram 300 for applying machine learning models (304) to paired sensor data and translating the results according to some aspects of the present disclosure. In this example, sensor data 302 from a source sensor (e.g., LiDAR, camera, or some other sensor) is transmitted to a machine-learning model 304. The sensor data 302 may be associated with a source (first) sensor having first operational characteristics. The output 314 of machine-learning model 304 may then be provided to a discriminator 310, which uses measured data from a second (target) sensor, to determine a valid transformed output 316.

The example of FIG. 3 illustrates a configuration utilizing a deep convolutional neural network (DNN) as a machine-learning model 304, configured as an encoder-decoder network (306, 308) and a generative adversarial network (GAN) (e.g., 310). In some examples, the encoder 306 and decoder 308 may be configured with the encoder having multiple down-sampling layers, with increasing numbers of channels, while the decoder is configured with multiple up-sampling layers, with decreasing number of channels. Each down-sampling layer may be configured to reduce the sensor data 302 size by a predetermined amount (e.g., half, quarter) in every dimension. The number of channels may be also selected to be a certain amount (e.g., 2×) of that of the input layer in order to compress the total information in order to reduce and abstract the data. Latent features may be produced from an output from a middle layer of the encoder-decoder configuration, and each up-sampling layer may recover the sensor data by increasing the reduced sensor data by a proportional amount.

The encoder-decoder network (306, 308) may be configured with skip connections that wire the output of respective down-sampling layer(s) to the input of a last up-sampling layer. Multiple inputs to certain ones of the up-sampling layers may be stacked as extra channels. The skip connections may be configured to transfer the raw, non-abstract sensor information directly to the final output. Such a configuration may be advantageous for mitigating the vanishing gradient problem and/or to accelerate learning, among others.

In some examples, the encoder may be configured to receive a plurality of source sensor data (302) inputs (xᵢ=x₁, x₂, . . . ) and the decoder may be configured to receive corresponding target data inputs (yᵢ=y₁, y₂, . . . ). The encoder may select a source sensor data input (xᵢ) and provide it to the decoder, which may then reconstruct the sensor data using yᵢ, where the output may be compared to corresponding actual yᵢ data (e.g., target sensor data 312 ground truth). The output may then be fed back to the encoder/decoder in order to improve the contents of the processed sensor data until sensor data may be translated from a source sensor to a target sensor without relying on ground truth data (e.g., from 312). The performance of the encoder/decoder may be evaluated using a reconstruction loss function d(y, yᵢ) that measures differences between the decoder output and target sensor data 312. In some examples, an L^{P} distance may be used between y′ and y, where y′ and y are high dimensional vectors. Thus, an L² distance, representing the mean-squared sensor data error, and the L¹ distance, representing a mean absolute sensor data error, may be used.

In some examples, the encoder/decoder (306, 308) may be considered a generator for generating transformed sensor data, while the discriminator 310 may be configured to evaluate the performance of the generator. This performance may be measured in terms of a loss function that may gauge the accuracy of the generator (306, 308) in terms of a value, where, for example, a lower value indicates a more accurate output. In this example, the discriminator 310 may be configured as an encoder-decoder DNN that includes down-sampling layers that are similar to ones used for classification tasks.

Continuing with the example of FIG. 3, the sensor data 302 may be utilized as paired of a paired sensor dataset that includes pairs of aligned sensor data in a source domain A and target domain B. Here, a function of the generator (304) f may be configured to learn to convert x ∈ A to f (x) ∈ B. Using a paired sensor dataset, the discriminator 310 may be trained to discriminate a pair (x, y) of sensor data and the corresponding measured target sensor data (x, f(x)). The discriminator 310 may be configured to classify the outputs of the generator (304) so that any classification loss may be used to train the discriminator (310) to operate as a conditional GAN. Thus, the generator (304) may be provided with x ∈ A and be trained to optimize a weighted sum of the reconstruction loss measuring the similarity between y and f(x) and the adversarial loss, which may be considered the negative of the discriminator's loss for (x, f(x)), resulting in a supervised learning mode of operation.

Once processed, the output produced by 314 may be utilized by a vehicle (e.g., 101, via processing apparatus 107) to engage in perception processing to classify/identify sensor objects (e.g., roads, pedestrians, vehicles, etc.) and/or sensed environment conditions (e.g., distance, location, etc.). In one example, the perception processing may be based on further machine-learning techniques such as fast (or faster) region-based convolutional networks (Fast/Faster R-CNN). In one example, two networks may be configured that include a region proposal network (RPN) for generating region proposals and a network for using these proposals to classify/detect objects and/or environments. Instead of using selective search for data of interest, a fast R-CNN may be configured to generate region proposals, where time cost of generating region proposals is smaller in RPN than selective search. The RPN may be configured to share most computation with the object detection network, which may be executed by the processing apparatus 107. The RPN may be configured to ranks region boxes (anchors) and proposes the ones most likely containing objects.

Alternately or in addition, a YOLOv2-based architecture may be used to detect objects and/or environments based on the output produced from 314. In this example, a single neural network may be applied to the output produced by 314, and the data divided into regions, where bounding boxes and probabilities are predicted for each region. The bounding boxes may be weighted by the predicted possibilities. The architecture may be configured to look at the sensor data as a whole at testing, so that predictions may be informed by the global context of the sensor data. In some configurations, techniques such as OverFeat and single-shot multibox detectors (SSD) may be used in a fully-convolutional model to improve training and improve performance.

It should be understood by those skilled in the art that the example of FIG. 3 is merely one example, and that a variety of other suitable machine-learning algorithms and configurations are contemplated in the present disclosure.

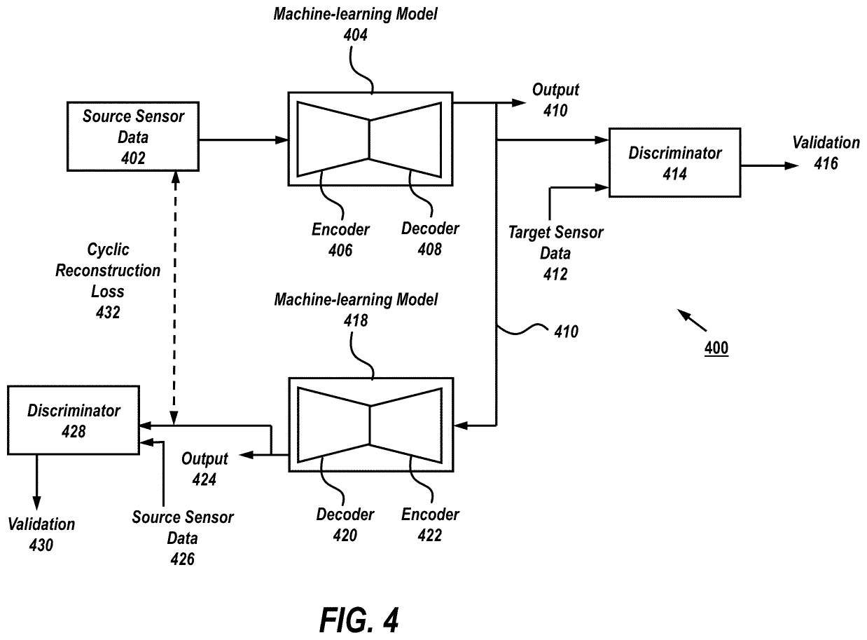

FIG. 4 shows an exemplary block diagram 400 for applying machine learning models to unpaired sensor data and translating the results according to some aspects of the present disclosure. The block diagram 400 of FIG. 4 may be configured to utilize functionalities described in block diagram 300 of FIG. 3, except that, as an unpaired sensor data environment, the output of machine-learning model 404 is fed back and compared to the source sensor data 402 to determine sensor accuracy for use in object/environment detection in a vehicle (e.g., 101). Here, sensor data 402 is subjected to machine learning model 404 (generator) that includes encoder 406 and decoder 408, which may be similar to encoder/decoder 306, 308 of FIG. 3. Similarly, discriminator 414 may be similar to discriminator 310 of FIG. 3, wherein the discriminator 414 processes the generator (404) output 410 with target sensor data 412 to produce a validated output 416, indicating the accuracy or quality of the sensor data. Additionally, a feedback 410 of the output of 404 is provided in this example, which is transmitted to machine-learning model 418 that includes encoder 422 and decoder 420 that may be configured and trained to convert data in the opposite direction of the target domain produced by machine-learning model 404. The output of machine-learning model 418 may then be transmitted to discriminator 428 that is configured to operate similarly as discriminator 414, except discriminator 428 is configured to discriminate based on the domain of sensor data 402 to produce an output 424, indicating a valid output 424. In an unpaired sensor environment, the output 424 may then be utilized by a vehicle (e.g., 101, via processing apparatus 107) to engage in perception processing to classify/identify sensor objects (e.g., roads, pedestrians, vehicles, etc.) and/or sensed environment conditions (e.g., distance, location, etc.), similar to the examples provided above in connection with FIG. 3.

During operation, unpaired sensor datasets may include sensor data from source domain A and an independent set of sensor data from target domain B. Here, it may not necessarily be known which data in domain A has corresponding data in domain B. Thus, a generator (e.g., 404) may be configured to convert x ∈ A to f (x) ∈ B, and the discriminator (e.g., 414) may be trained to distinguish real sensor data y from the generated sensor data f(x) using available sensor data 412 (e.g., ground truth). However, in this example, y and x may be independent and may not necessarily correlate to one another. Accordingly, it may be necessary to define a reconstruction loss, if a ground truth sensor data set is unavailable. Here, another generator that includes machine-learning model 418 having encoder 422 and decoder 420, as well as discriminator 428 are configured and trained to covert sensor data in the opposite direction from the target domain B to the source domain A. Thus, converted sensor data may be converted to the original sensor domain and vice-versa, and a cycle consistency loss may be optimized, where the cycle consistency loss may be expressed as |x−g(f(x))|²+|y−g(f(y))|². Such a configuration enables unsupervised learning and allows the system to learn one-to-one mappings. Alternately or in addition, cyclic reconstruction loss 432 may be performed between the output 424 of machine-learning model 418 and the source sensor data 402 to improve stability of training. The discriminator 428 may be configured to process output 424 with source sensor data 426 to provide a validation output 430 that determines the accuracy and/or quality of the data.

Suitable machine-learning techniques for translating sensor data may include, but are not limited to, Pix2Pix, Pix2PixHD, Pix2PixGAN and/or CycleGAN. While such algorithms have been utilized for image translation, they have been found by the inventors to be advantageous in applications using sensor data in various domains (e.g., vehicle camera video, LiDAR, etc.). Instead of taking as input a fixed-size vector, the configuration of FIG. 4 may take sensor data from one domain and output corresponding sensor data in another domain (e.g., LiDAR data from one platform to another). Skip connections may be utilized to ensure that more features flow from input to output during forward propagation and gradients from loss to parameters during back-propagation. In some examples, unlike architectures that classify a whole dataset as valid or invalid, the GAN architecture of FIG. 4 may classify patches of sensor data as valid or invalid by outputting a matrix of values as output instead of a single value. Such a configuration encourages sharper high frequency detail and also to reduces the number of parameters.

In one example, skip connections may be utilized in the encoder/decoder (e.g., similar to a U-Net configuration), where outputs of a down-sampling layer may be wired to the last up-sampling layer, and wherein two inputs to each up-sampling layer may be stacked as extra channels. For training, several techniques may be utilized for stable training including, but not limited to, Wasserstein GAN with gradient penalty (WGAN-GP), progressive growing GAN (PGGAN) and/or spectral normalization. Additional noise-reduction techniques may further be applied to provide sensor data output with improved characteristics.

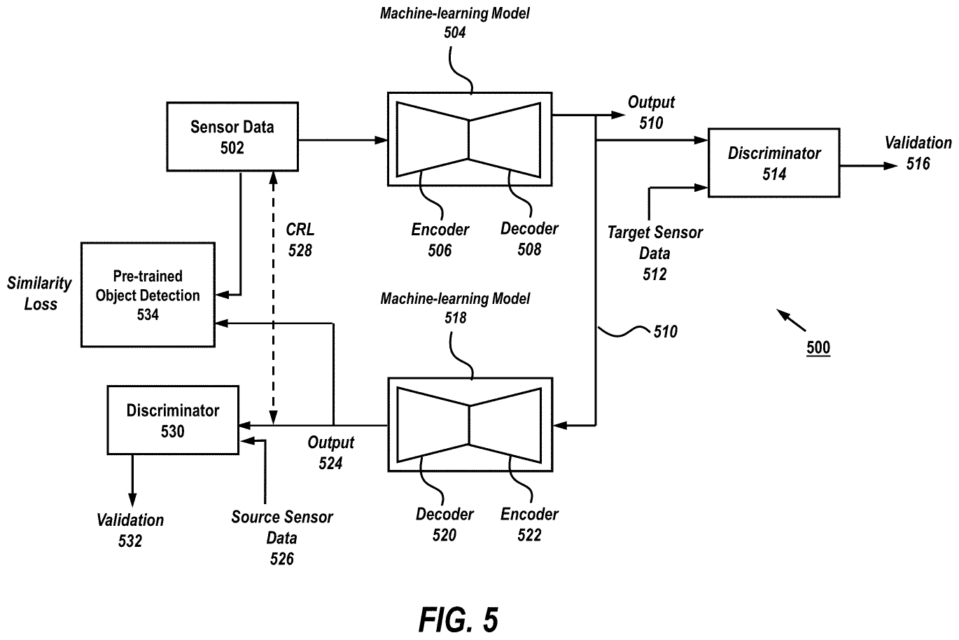

FIG. 5 shows an exemplary block diagram 500 for applying machine learning models to unpaired sensor data and translating the results according to some aspects of the present disclosure. The block diagram 500 of FIG. 5 may be configured to utilize functionalities described in block diagram 400 of FIG. 4, except that the feedback for the sensor data is focused on objects of interest for use in object/environment perception detection in a vehicle (e.g., 101). Here, sensor data 502 is subjected to machine learning model 504 (generator) that includes encoder 506 and decoder 508, which may be configured similarly as encoder/decoder 406, 408 of FIG. 4. Similarly, discriminator 514 may be configured similarly to discriminator 414 of FIG. 4, wherein the discriminator 514 processes the generator output 510 with target sensor data 512 to produce a validated output 516, indicating the accuracy or quality of the sensor data. Additionally, a feedback 510 of the output of 504 is provided in this example, which is transmitted to machine-learning model 518 that includes encoder 522 and decoder 520 that may be configured and trained to convert data in the opposite direction of the target domain produced by machine-learning model 504. The output of machine-learning model 518 may then be transmitted to discriminator 530 that is configured to operate similarly as discriminator 504, except discriminator 530 is configured to discriminate based on the domain of source sensor data 526 to produce a validation output 532 indicating the accuracy/quality of the translated signal (524). In an unpaired sensor environment, the output 524 may then be utilized by a vehicle (e.g., 101, via processing apparatus 107) to engage in perception processing to classify/identify sensor objects (e.g., roads, pedestrians, vehicles, etc.) and/or sensed environment conditions (e.g., distance, location, etc.).

As discussed above in connection with FIG. 4, during operation, unpaired sensor datasets may include sensor data from source domain A and an independent set of sensor data from target domain B. A generator (e.g., 504) may be configured to convert x ∈ A to f (x) ∈ B, and the discriminator (e.g., 514) may be trained to distinguish real sensor data y from the generated sensor data f(x) using available sensor data 512 (e.g., ground truth). In some examples, it may be necessary to define a reconstruction loss, if a ground truth sensor data set is unavailable. Here, another generator that includes machine-learning model 518 having encoder 522 and decoder 520, as well as discriminator 530 are configured and trained to covert sensor data in the opposite direction from the target domain B to the source domain A. Thus, converted sensor data may be converted to the original sensor domain and vice-versa, and a cycle consistency loss may be optimized. Such a configuration enables unsupervised learning and allows the system to learn one-to-one mappings. Alternately or in addition, cyclic reconstruction loss 528 may be performed between the output 524 of machine-learning model 518 and the source sensor data 526 to improve stability of training. The discriminator 530 may be configured to process the output 524 with source sensor data 526 to provide a validation output 532 that determines the accuracy and/or quality of the data. Suitable machine-learning techniques for translating sensor data may include, but are not limited to, Pix2PixGAN and/or CycleGAN. Alternately or in addition, the output 524 of machine-learning model 518 and source sensor data 502 may be transmitted through a pre-trained object detection circuit 534 (and/or pre-trained object detection network) to extract features in order to determine similarity losses that can help the machine learning models to focus on the relevant objects of interest during the sensor translation process.

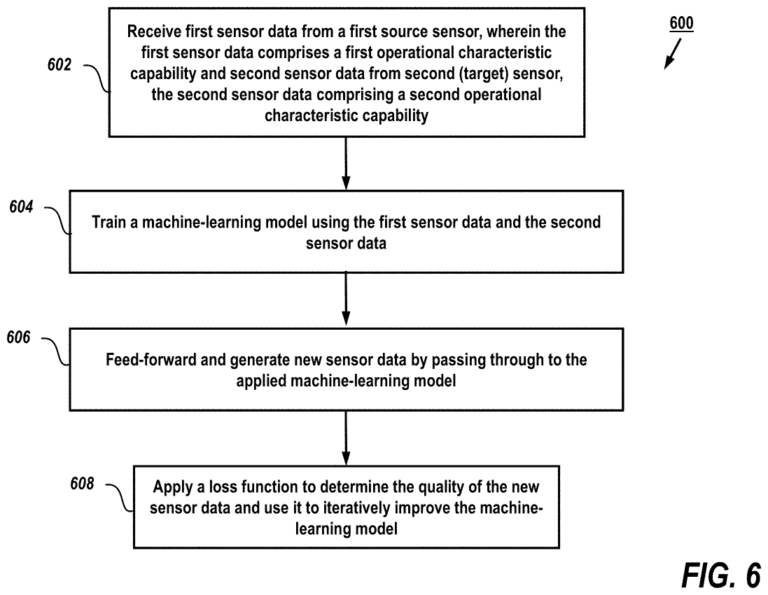

FIG. 6 shows an exemplary process flow 600 for training paired sensor data and producing new sensor data (e.g., source sensor data translated into second sensor domain) resulting from the translation of a characteristic of interest from a first sensor having a first operational characteristic, to a second sensor having a second operational characteristic data under some aspects of the disclosure. The process flow 600 may be executed on a vehicle (e.g., 101) equipped with a suitable processing device (e.g., 107). Alternately or in addition, the process flow 600 may be executed on an external processing device communicatively coupled to a vehicle (e.g., 101). In some examples, the vehicle may include an input (e.g., 106, 111, 112) for receiving first sensor data from a first sensor (e.g., 104), wherein the first sensor data comprises a first operational characteristic capability, a memory (e.g., 108), coupled to the input for storing the first sensor data and a processor (e.g., 107), operatively coupled to the memory, wherein the processor and memory are configured to perform the functions in process flow 600.

In block 602, the processor and memory receive first sensor data from a first sensor (e.g., source sensor), wherein the first sensor data comprises a first operational characteristic capability, and second sensor data from a second (e.g., target) sensor, the second sensor data comprising a second operational characteristic capability. In block 604, the processor and memory train a machine-learning model using the first sensor data and the second sensor data, wherein the machine-learning model is trained to second sensor data (e.g., target sensor) comprising a second operational characteristic capability. As used herein, “operational capability” refers generally to a mode or ability of operation. In block 606, the processor and memory feed forward and generate new sensor data by passing the first/second sensor data to the applied machine-learning model. In block 608 the processor and memory may apply a loss function to determine the accuracy/quality of the new sensor data and use it to iteratively improve the machine-learning model .

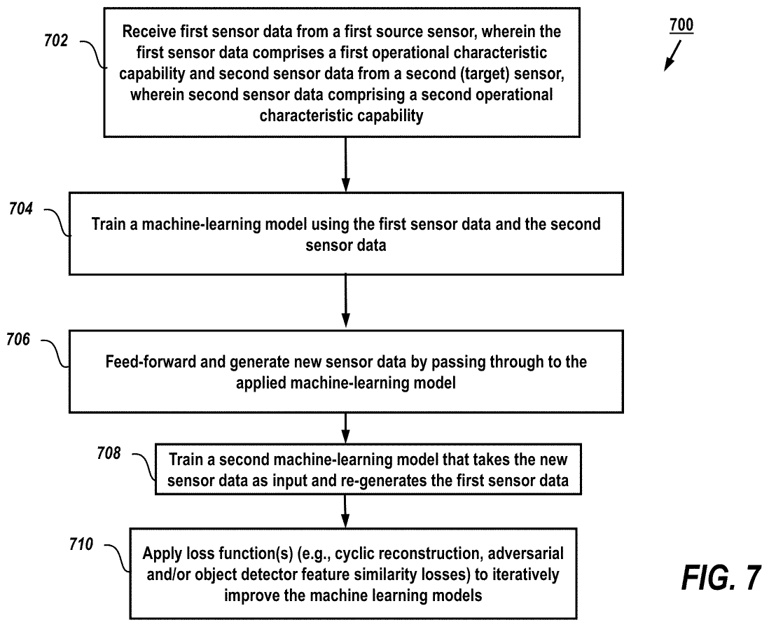

FIG. 7 shows an exemplary process flow 700 for training unpaired sensor data and producing new sensor data resulting from the translation of first and second sensor data under some aspects of the disclosure. In block 702, a processor and memory receive first sensor data from a first source sensor (e.g., 402, 502), wherein the first sensor data comprises a first operational characteristic capability and second sensor data from a second (target) sensor (e.g., 412, 512), wherein second sensor data comprises a second operational characteristic capability. In block 704, the processor and memory are configured to train a machine learning model (e.g., 404, 504) using the first sensor data and second sensor data. In block 706, the processor and memory feed-forward and generate new sensor data by passing through to the applied machine-learning model (e.g., 404, 504). In block 708, the processor and memory train a second machine-learning model (e.g., 418, 518) that takes the new sensor data as input and re-generates the first sensor data as output (e.g., 424, 524). In block 710, the processor and memory may apOply a loss function (e.g., cyclic reconstruction, adversarial and/or object detector feature similarity losses) to iteratively improve the machine learning models.

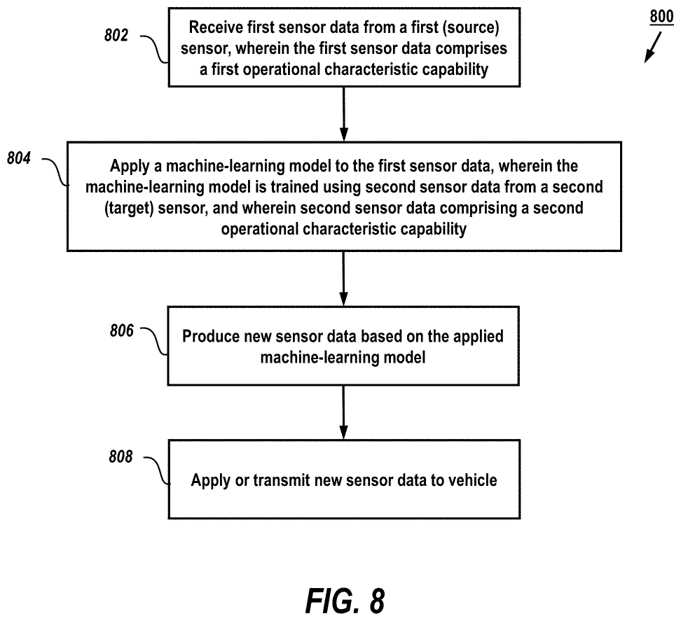

FIG. 8 shows an exemplary process flow 800 for applying new sensor data, produced from translating first sensor data to second sensor data via a machine-learning model, to a vehicle (e.g., 101). In block 802, a processor and memory may receive first sensor data from a first (source) sensor, wherein the first sensor data comprises a first operational characteristic capability. In block 804, the processor and memory may apply a machine-learning model to the first sensor data, wherein the machine-learning model is trained using second sensor data from a second (target) sensor, and wherein second sensor data comprising a second operational characteristic capability. In block 806, the processor and memory may produce new sensor data based on the applied machine-learning model. In block 808, the processor and memory may apply (e.g., in vehicle 101) or transmit (e.g., via server/cloud 216) new sensor data to the vehicle.

One of ordinary skill in the art will recognize that the technologies and techniques disclosed herein provide sensor translation abilities that allow translation of an entire data set of a source sensor to a target sensor, or only one or more characteristics of interest. Unlike conventional algorithms, which simply translate pictorial images, the technologies and techniques disclosed herein allow for a user to translate a characteristic of interest from a sensor including, but not limited to, sensor resolution, coloration, perspective, field-of-view, scanning pattern, maximum range and receiver characteristics. The sensor translation may be performed using paired sensor or unpaired sensors, discussed above.

As described above, some or all illustrated features may be omitted in a particular implementation within the scope of the present disclosure, and some illustrated features may not be required for implementation of all examples. In some examples, the methods and processes described herein may be performed by a vehicle (e.g., 101), as described above and/or by a processor/processing system or circuitry (e.g., 102-111, 210, 212) or by any suitable means for carrying out the described functions.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method of operating a sensor system, comprising:
receiving first sensor data generated using a first sensor and second sensor data generated using a second sensor, wherein the first sensor data comprises a first operational characteristic capability, and wherein the second sensor data comprises a second operational characteristic capability;
training a machine-learning model, wherein the machine-learning model is trained to output the second sensor data based on input of the first sensor data;
generating new sensor data using the applied machine-learning model;
applying a loss function to the new sensor data to determine the accuracy of the new sensor data relative to the first sensor data and the second sensor data; and
operating the second sensor based on data from the machine learning model.

2. The method of claim 1, wherein applying the machine-learning model comprises applying a deep neural network (DNN).

3. The method of claim 2, wherein the DNN is an encoder-decoder network with conditional adversarial loss.

4. The method of claim 1, wherein applying the loss function to the new sensor data comprises applying a reconstruction loss function to the new sensor data relative to the second sensor data.

5. The method of claim 1, wherein applying the loss function to the new sensor data comprises
applying a second machine-learning model to the new sensor data, wherein the second machine-learning model is trained to the first sensor data to produce modified new sensor data, and wherein the second machine-learning model comprises a deep convolutional neural network (DNN).

6. The method of claim 5, wherein the DNN comprises an encoder-decoder network, configured to process the new sensor data in the opposite direction of the machine learning model.

7. The method of claim 1, wherein the first operational characteristic capability and the second operational characteristic capability comprises one or more of sensor resolution, coloration, perspective, field-of-view, scanning pattern, maximum range and/or receiver characteristics.

8. A system for converting sensor data from a first operational characteristic to a second operational characteristic, comprising:
an input for receiving first sensor data from a first sensor, wherein the first sensor data comprises a first operational characteristic capability;
a memory, coupled to the input for storing the first sensor data; and
a processor, operatively coupled to the memory, wherein the processor and memory are configured to
receive first sensor data generated using a first sensor and second sensor data generated using a second sensor, wherein the first sensor data comprises a first operational characteristic capability, and wherein the second sensor data comprises a second operational characteristic capability;
train a machine-learning model, wherein the machine-learning model is trained to output the second sensor data based on input of the first sensor data;
generate new sensor data using the applied machine-learning model; and
apply a loss function to the new sensor data to determine the accuracy of the new sensor data relative to the first sensor data and the second sensor data.

9. The system of claim 8, wherein the processor and memory are configured to apply the machine-learning model by applying a deep neural network (DNN).

10. The system of claim 9, wherein the DNN comprises an encoder-decoder network.

11. The system of claim 8, wherein the processor and memory are configured to apply the loss function to the new sensor data by applying a reconstruction loss function to the new sensor data relative to the second sensor data.

12. The system of claim 8, wherein the processor and memory are configured to apply the loss function to the new sensor data by applying a second machine-learning model to the new sensor data, wherein the second machine-learning model is trained to the first sensor data to produce modified new sensor data, and wherein the second machine-learning model comprises a deep neural network (DNN).

13. The system of claim 12, wherein the DNN comprises an encoder-decoder network, configured to process the new sensor data in the opposite direction of the machine learning model.

14. The system of claim 8, wherein the first operational characteristic capability and the second operational characteristic capability comprises one or more of sensor resolution, coloration, perspective, field-of-view, scanning pattern, maximum range and/or receiver characteristics.

15. A method of operating a sensor system, comprising:
receiving first sensor data generated using a first sensor and second sensor data generated using a second sensor, wherein the first sensor data comprises a first operational characteristic capability, and wherein the second sensor data comprises a second operational characteristic capability;
training a machine-learning model, wherein the machine-learning model is trained to output the second sensor data based on input of the first sensor data;
generating new sensor data using the applied machine-learning model, wherein the new sensor data comprises data converted from the first sensor data to the second sensor data corresponding to at least the one or more features of interest; and
applying a loss function to the new sensor data to determine the accuracy of the new sensor data relative to the first sensor data and the second sensor data.

16. The method of claim 15, wherein applying the machine-learning model comprises applying a deep neural network (DNN) comprising an encoder-decoder network.

17. The method of claim 15, wherein applying the loss function to the new sensor data comprises applying a reconstruction loss function to the new sensor data relative to the second sensor data.

18. The method of claim 15, wherein applying the loss function to the new sensor data comprises
applying a second machine-learning model to the new sensor data, wherein the second machine-learning model is trained to the first sensor data to produce modified new sensor data, and wherein the second machine-learning model comprises a deep convolutional neural network (DNN).

19. The method of claim 18, wherein the DNN comprises an encoder-decoder network, configured to process the new sensor data in the opposite direction of the machine learning model.

20. The method of claim 15, wherein the first operational characteristic capability and the second operational characteristic capability comprises one or more of sensor resolution, coloration, perspective, field-of-view, scanning pattern, maximum range and/or receiver characteristics.
